(19) United States
(12) Patent Application Publication
(10) Pub. No.: US 2008/0137148 A1
(43) Pub. Date: Jun. 12, 2008

(54) IMAGE PROCESSING APPARATUS AND IMAGE PROCESSING METHOD

(75) Inventors: Hyun-soo OH, Suwon-si (KR); Kyeong-man Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/849,594

(22) Filed: Sep. 4, 2007

(30) Foreign Application Priority Data
Dec. 7, 2006 (KR) 2006-123754

(51) Int. Cl. G06K 15/00

(52) U.S. Cl. 358/3.23; 358/3.01; 382/162

(57) ABSTRACT

An image processing method which changes a color image into a gray image, the image processing method including determining a plurality of representative colors, assigning gray values to the representative colors so that range variations between the gray values within a predetermined range are less than a predetermined value, and assigning a gray value to an arbitrary color of the color image according to a degree of similarity between the arbitrary color and the representative colors.

### CROSS-REFERENCE TO RELATED APPLICATIONS

This application claims priority under 35 U.S.C. §119(a) from Korean Patent Application No. 10-2006-0123754, filed on Dec. 7, 2006 in the Korean Intellectual Property Office, the disclosure of which is incorporated herein in its entirety by reference.

### BACKGROUND OF THE INVENTION

1. Field of the Invention

The present general inventive concept relates to an image processing apparatus and an image processing method thereof, and more particularly, to an image processing apparatus which converts a color image to be printed into a gray image, and an image processing method thereof.

2. Description of the Related Art

An image processing apparatus, such as a computer system, is provided as a host apparatus of a printer, a multi-function printer, etc. (hereinafter, referred to as a printing apparatus) and controls operations of the printing apparatus according to a user's commands. The image processing apparatus changes a data of an original image of a picture, a text, or the like to be printed into a data which can be processed by the printing apparatus (hereinafter, referred to as a printing data) and transmits the printing data to the printing apparatus. The printing apparatus performs printing of the printing data to form an output image on a printing medium, such as a paper.

The original image may be provided as a color image which is represented by an RGB color space or an RGB color model. The color image may be converted into a gray image to be printed. A gray image being defined as one of a gray-scale and a monochromatic representation of the color image. Generally, a conversion from a color image into a gray image (hereinafter, referred to as a gray conversion) may be performed by using a luminance element only in a color space such as Hue Saturation Lightness (HSL), CIELab, YCbCr, etc. For example, the image processing apparatus converts an RGB image, which is an image of the RGB color space, into a YCbCr image, which is an image of the YCbCr color space, by a conversion equation between different color spaces, thereby obtaining a gray image using only a luminance element, i.e., a Y element, of the converted image.

However, since a conventional conversion method takes a luminance element of a Y element but drops a chrominance element of a CbCr element for a gray conversion, images with different colors but similar brightnesses may not be distinguished on gray images.

For example, FIG. 1 shows printing results of an RGB image 1 and a first gray image 2 into which the RGB image 1 is gray-converted by the conventional conversion method. Referring to FIG. 1, figures of the RGB image 1 are all obviously distinguished, while some figures of the gray image 2 are not distinguished clearly but just show some brightness difference.

### SUMMARY OF THE INVENTION

The present general inventive concept provides an image processing apparatus and an image processing method to clearly distinguish objects when a color image to be printed is converted into a gray image.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an image processing method which changes a color image into a gray image, the image processing method comprising determining a plurality of representative colors, assigning gray values to the representative colors so that range variations between the gray values within a predetermined range are less than a predetermined value, and assigning a gray value to an arbitrary color of the color image according to a degree of similarity between the arbitrary color and the representative colors.

The color image may be an RGB image, and the determining of the representative colors may determine black, blue, red, magenta, green, cyan, yellow, and white as the representative colors.

Range values between the gray values assigned to the representative colors may be regular.

The assigning of the gray values to the representative colors may comprise compensating for a characteristic of brightness output of a printing apparatus which performs printing of the converted gray image.

In the assigning of the gray value to the arbitrary color, the degree of similarity may correspond to a relative position of a point corresponding to the arbitrary color to points corresponding to the representative colors in an RGB color space.

In the assigning of the gray value to the arbitrary color, points, among the points corresponding to the representative colors, which are closer to the point corresponding to the arbitrary color in the RGB color space may be given greater weight.

The foregoing and/or other aspects and utilities of the present general inventive concept can be achieved by providing an image processing apparatus which converts a color image into a gray image, the image processing apparatus comprising an image processor to determine a plurality of representative colors, to assign gray values to the representative colors so that range variations between the gray values within a predetermined range are less than a predetermined value, and to assign a gray value to an arbitrary color of the color image according to a degree of similarity between the arbitrary color and the representative colors.

The color image may be an RGB image, and the image processor may determine black, blue, red, magenta, green, cyan, yellow, and white as the representative colors.

All ranges between the gray values assigned to the representative colors may be uniform.

The image processor may assign the gray values to the representative colors to compensate for a characteristic of brightness output of a printing apparatus to print the converted gray image.

The degree of similarity may correspond to a relative position of a point corresponding to the arbitrary color to points to corresponding to the representative colors in an RGB color space.

The image processor may give gray values of greater weight to points, among the points corresponding to the representative colors, which are closer to the point of the arbitrary color in the RGB color space.

The foregoing and/or other aspects and utilities of the present general inventive concept are also achieved by providing an image processing method to change color printing data to monochromatic printing data, comprising determining a plurality of representative colors of the color printing data, assigning non-overlapping gray value ranges for each of the representative colors determined, and assigning a grey value to each color of the color printing data according to the non-overlapping gray value range of the corresponding representative color.

The assigning of the grey value to each color may comprise determining a degree of similarity between a color of the color printing data and the determined representative colors, and assigning a grey value among the gray value range of the corresponding representative color based on the degree of similarity.

The determining of the plurality of representative colors may comprise converting the color printing data into an RGB color space, and the degree of similarity may correspond to a relative position of a point corresponding to the color to points corresponding to the representative colors in the RGB color space.

The assigning of the non-overlapping gray value ranges for each of the representative colors determined may comprise assigning non-overlapping gray value ranges according to NTSC guidelines.

The assigning of the non-overlapping gray value ranges for each of the representative colors determined may comprise assigning non-overlapping gray value ranges in a specific order to improve distinction of a particular representative color.

The method may further comprise storing a predetermined lookup of non-overlapping grey values ranges corresponding to predetermined colors, wherein the assigning of the non-overlapping gray value ranges for each of the representative colors determined is performed according to the lookup table.

The foregoing and/or other aspects and utilities of the present general inventive concept are also achieved by providing a computer readable recording medium comprising computer readable codes to change color printing data to monochromatic printing data, comprising determining a plurality of representative colors of the color printing data, assigning non-overlapping gray value ranges for each of the representative colors determined, and assigning a grey value to each color of the color printing data according to the non-overlapping gray value range of the corresponding representative color.

The foregoing and/or other aspects and utilities of the present general inventive concept are also achieved by providing a computer readable recording medium comprising computer readable codes to change a color image into a gray image, the image processing method comprising determining a plurality of representative colors, assigning gray values to the representative colors so that range variations between the gray values within a predetermined range are less than a predetermined value, and assigning a gray value to an arbitrary color of the color image according to a degree of similarity between the arbitrary color and the representative colors.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings of which:

FIG. 1 illustrates a printed first gray image into which an RGB image is gray-converted by a conventional conversion method;

FIG. 2 illustrates a block diagram of an image processing apparatus according to an exemplary embodiment of the present general inventive concept;

FIG. 3 illustrates an RGB color space to display eight representative colors of red (R), green(G), blue (B), cyan (C), magenta (M), yellow (Y), black (K), and white (W);

FIG. 4 illustrates brightness output of a printing apparatus according to input of a linearly-increasing gray value;

FIG. 5 illustrates gray values according to eight representative values (K, B, R, M, G C, Y, and W) of uniform brightness intervals;

FIG. 6 illustrates a printed second image into which an RGB image is gray-converted according to an exemplary embodiment of the present general inventive concept; and

FIG. 7 is a flow chart to illustrate an operation of the image processing apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

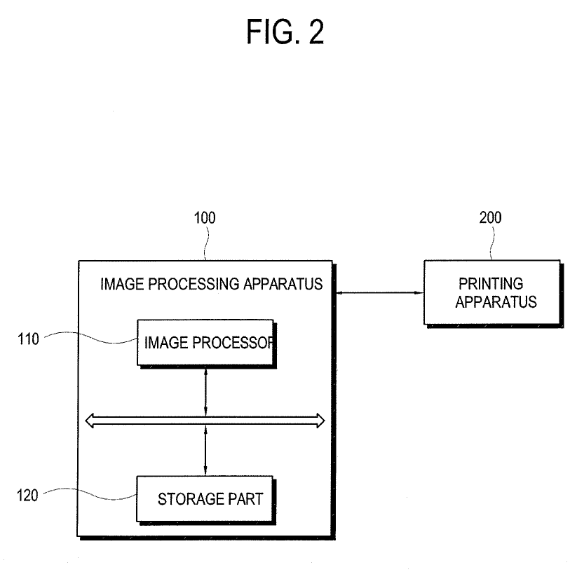

FIG. 2 illustrates a block diagram of an image processing apparatus according to an exemplary embodiment of the present general inventive concept. Referring to FIG. 2, the image processing apparatus 100, as a host apparatus of a printing apparatus 200, may be provided as a computer system. The image processing apparatus 100 processes a data of an original image of a picture, a photograph, a text, and other known images in the art by a process, such as a half-toning process or the like, to get a printing data and provides the printing data to the printing apparatus 200.

The printing apparatus 200 prints a printing data provided from the image processing apparatus 100 and forms an output image on a printing medium, such as a paper. The printing apparatus 200 may be realized by a printer, a multi-function printer and other known printing apparatuses in the art. The printing apparatus 200 can perform printing by an ink-jet method, a laser method, and other known printing methods in the art.

Referring to FIG. 2, the host apparatus 100 may include an image processor 110. The image processor 110 converts a data of an original image to be printed into a printing data which can be processed by the printing apparatus 200. Further, the image processor 110 performs a gray conversion to convert an original image from a color image to a gray image.

A color image may be provided as an RGB image. The image processor 110 assigns one gray value of a limited predetermined range to each of a plurality of colors in an RGB color space. For example, if a converted gray image is 8 bits, a gray value range may be between 0 and 255.

The image processor 110 determines a plurality of representative colors and assigns a gray value to a color by applying a weight to the gray value of the plurality of representative colors according to a degree of similarity between the determined representative colors and an arbitrary color of an RGB image to be converted.

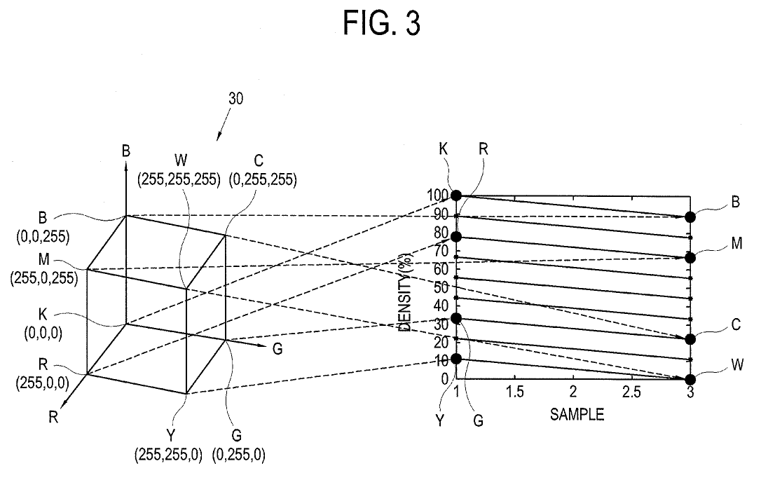

The representative colors are determined to correspond to a color space of a color image. For example, in an RGB color space, red (R), green (G), blue (B), cyan (C), magenta (M), yellow (Y), black (K), and white (W) can be determined as representative colors which are able to show relations with other colors. FIG. 3 illustrates an RGB color space 30 to display eight representative colors, such as red, green, blue, cyan, magenta, yellow, black, and white. In the RGB color space 30, coordinates of each colors (R, G, B, C, M, Y, K and W) are (255, 0, 0), (0, 255, 0), (0, 0, 255), (0, 255, 255), (255, 0, 255), (255, 255, 0), (0, 0, 0) and (255, 255, 255), respectively.

Gray values are assigned to the respective representative colors to clearly distinguish objects in a converted gray image. That is, the eight gray values may be assigned to the respective representative colors so that range variations between the gray values are less than a predetermined value. For example, the range variations between the eight gray values assigned to the eight representative colors may become zero, i.e., the respective range values between the gray values may be regular.

The gray values may be assigned to the representative colors considering a National Television System Committee (NTSC) color order to reflect brightness which a user perceives. That is, the gray values can be assigned to the representative colors in order of black, blue, red, magenta, green, cyan, yellow, and white. FIG. 3 illustrates an order of assigning the gray values to the eight representative colors (K, B, R, M, G, C, Y, and W).

Alternatively, if it is necessary to distinguish a specific color, the color may be assigned a gray value by a different order of assigning the gray values to improve its distinction.

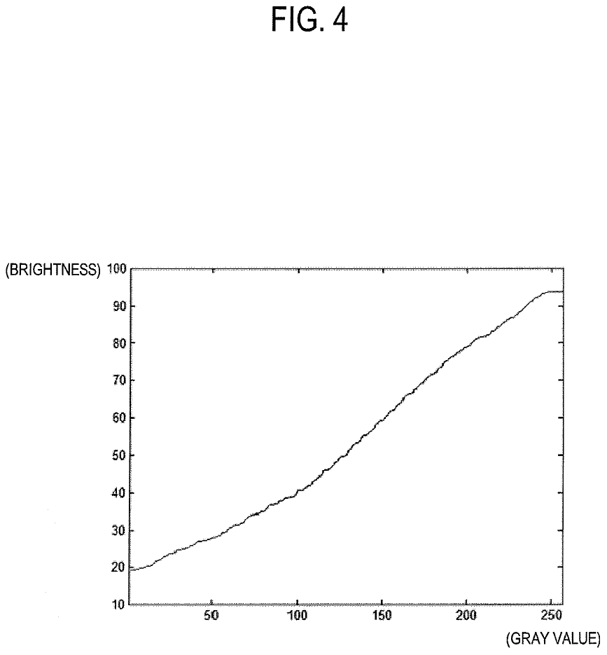

A characteristic of the printing apparatus 200 may be reflected when the gray values are assigned to the representative colors. FIG. 4 illustrates brightness output by the printing apparatus 200 on a gray value which is linearly and increasingly input. Here, a gray test chart of 256 levels may be used as the input. Referring to FIG. 4, the printing apparatus 200 may have a characteristic of non-linear brightness output on the gray value which linearly increases. This characteristic of the brightness output causes distinction of an output image to be reduced.

In the present exemplary embodiment, the gray values can be assigned to the eight representative colors to compensate for a non-linear characteristic of the brightness output of the printing apparatus 200. The characteristic of the brightness output may be compensated using an equation 1 and an equation 2 below.

$$\begin{matrix}l = \frac{L max - L min}{N - 1} & [ Equation 1 ] \\ \begin{matrix}{L}_{N} = \{ {L}_{0} , {L}_{1} , {L}_{2} … {L}_{N - 1} \} \\ = \{ 0 , l , 2 l , … ( N - 1 ) l \}\end{matrix} & [ Equation 2 ]\end{matrix}$$

Here, I represents a brightness range value, Lmax represents a maximum output brightness value on the gray test chart of the 256 levels, Lmin represents a minimum output brightness value, and N represents the number of the representative colors. L_{N} represents target brightness to the respective representative colors.

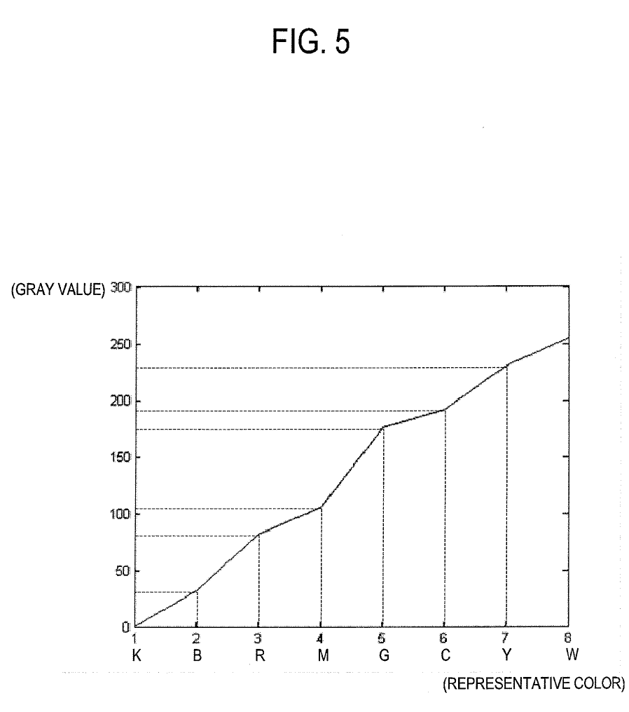

According to equation 1 and equation 2, the plurality of target brightness corresponding to the plurality of representative colors are regular in each range. For example, the eight gray values assigned to the eight representative colors (K, B, R, M, G C, Y, and W) correspond to the target brightness L_{N} illustrated in the graph of FIG. 4 and are given as 0, 32, 82, 106, 176, 230, and 255. FIG. 5 illustrates the gray values about the eight representative values with regular brightness range values.

Next, an arbitrary color of an RGB image to be converted is assigned a gray value as described below. The image processor 110 assigns a gray value to an arbitrary color according to a degree of similarity between the representative colors and the arbitrary color of the RGB image to be converted by applying weight to the gray values of the representative colors.

Referring to FIG. 3, the weight is determined by a relative position of a point corresponding to an arbitrary color to points of the eight representative colors (K, B, R, M, G, C, Y, and W) in the RGB color space 30. That is, points, among the points corresponding to the eight representative colors, which are closer to the point corresponding to the arbitrary color, are given greater weight.

If an RGB image is 24 bits, a gray value is assigned to an arbitrary color by an equation 3 and an equation 4 below.

gray 1=c[0+(c[1]xr0)/255+(c[2]xg0)/255+(c[3]xb0)/255+(c[4]xr0xb0)/65025+(c[5]xg0xb0)/65025 [Equation 3]

gray 2=c[0+(c[6]xr0)/255+(c[7]xg0)/255+(c[8]xb0)/255+(c[9]xr0xb0)/65025+(c[10]xg0xb0)/65025 [Equation 4]

In equations 3 and 4, gray 1 and gray 2 represent a gray value assigned to an arbitrary color, and r0, g0, and b0 represent an RGB element value of the color. Equation 3 is employed when r0 of the color is higher than g0 thereof, and equation 4 is employed otherwise. c[0] to c[10] represent a parameter, and values thereof are as follows:
c[0]=k;
c[1]=r−k;
c[2]=y−r;
c[3]=b-k;
c[4]=m-b-r+k
c[5]=w-m-y+r;
c[6]=y−g;
c[7]=g−k;
c[8]=b-k;
c[9]=w-c-y+g; and
c[10]=c-b-g+k.

Here, k, b, r, m, g, c, y, and w are the gray values assigned to the eight representative colors (K, B, R, M, G, C, Y, and W).

A lookup table may be used for the gray conversion by the image processor 110. The lookup table may include the eight representative colors (K, B, R, M, G, C, Y, and W) and the gray values corresponding thereto. The gray values may be assigned to the eight representative colors considering the characteristics of the printing apparatus 200. The image processing apparatus 100 may further include a storage part 120 which stores the lookup table.

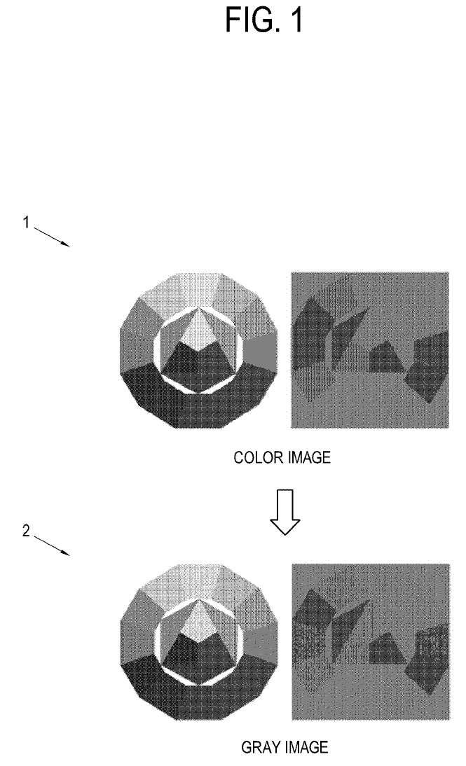

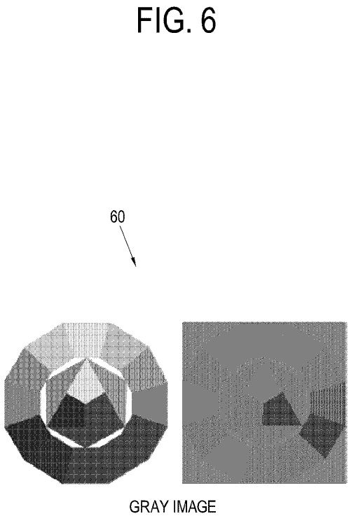

FIG. 6 illustrates a printed second image 60 into which the RGB image 1 illustrated in FIG. 1 is gray-converted according to an exemplary embodiment of the present general inventive concept. Unlike the first gray image 2 illustrated in FIG. 1, the second gray image 60 of FIG. 6 has figures which are clearly distinguished.

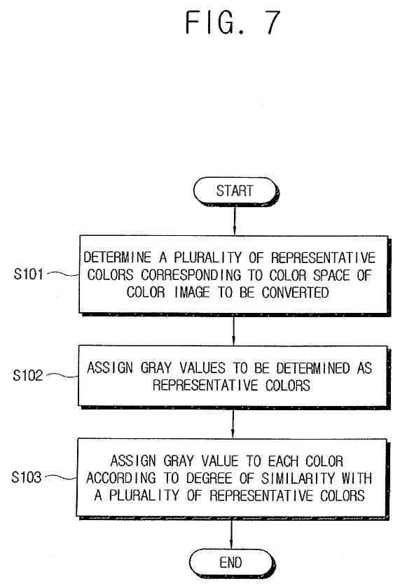

FIG. 7 is a flow chart to illustrate an operation of the image processing apparatus 100 according to an exemplary embodiment of the present general inventive concept. First, a plurality of representative colors are determined to correspond to a color space of a color image to be converted in operation S101. If the color image to be converted is in an RGB color space, black, blue, red, magenta, green, cyan, yellow, and white are determined as eight representative colors.

Then, gray values are assigned to the determined representative colors so that range variations between the gray values are less than a predetermined value n operation S102. In operation S102, for example, the range values between the gray values may be regular. Also, compensation may be performed to reflect characteristics of the printing apparatus 200. In this case, the gray values are determined to consider a brightness characteristic of the printing apparatus 200 so that all brightness ranges corresponding to the representative colors are regular.

Next, a gray value is assigned to an arbitrary color of a color image n operation S103. At operation S103, the gray values of the representative colors are weighted according to a degree of similarity between the representative colors and the arbitrary color. In detail, the representative colors which are similar to the arbitrary color have greater weight.

Various embodiments of the present general inventive concept can be embodied as computer readable codes on a computer-readable medium. The computer-readable medium includes a computer-readable recording medium and a computer-readable transmission medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable transmission medium can be distributed over network coupled computer systems, through wireless or wired communications over the internet, so that the computer readable code is stored and executed in a distributed fashion. Various embodiments of the present general inventive concept may also be embodied in hardware or in a combination of hardware and software.

As described above, the present general inventive concept provides an image processing apparatus and an image processing method to clearly distinguish objects when a color image to be printed is converted into a gray image.

That is, gray values are assigned to colors in a color space so that range values between the gray values are maximally regular, thereby distinguishing objects in a gray image optimally.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image processing method which changes a color image into a gray image, the image processing method comprising:
determining a plurality of representative colors;
assigning gray values to the representative colors so that range variations between the gray values within a predetermined range are less than a predetermined value; and
assigning a gray value to an arbitrary color of the color image according to a degree of similarity between the arbitrary color and the representative colors.

2. The image processing method of claim 1, wherein:
the color image is an RGB image, and
the determining of the representative colors determines black, blue, red, magenta, green, cyan, yellow, and white as the representative colors.

3. The image processing method of claim 2, wherein range values between the gray values assigned to the representative colors are regular.

4. The image processing method of claim 2, wherein the assigning of the gray values to the representative colors comprises compensating for a characteristic of brightness output of a printing apparatus which performs printing of the converted gray image.

5. The image processing method of claim 4, wherein in the assigning of the gray value to the arbitrary color, the degree of similarity corresponds to a relative position of a point corresponding to the arbitrary color to points corresponding to the representative colors in an RGB color space.

6. The image processing method of claim 5, wherein in the assigning the gray value to the arbitrary color, points, among the points corresponding to the representative colors, which are closer to the point corresponding to the arbitrary color in the RGB color space are given greater weight.

7. An image processing apparatus to convert a color image into a gray image, the image processing apparatus comprising:
an image processor to determine a plurality of representative colors, to assign gray values to the representative colors so that range variations between the gray values within a predetermined range are less than a predetermined value, and to assign a gray value to an arbitrary color of the color image according to a degree of similarity between the arbitrary color and the representative colors.

8. The image processing apparatus of claim 7, wherein:
the color image is an RGB image, and
the image processor determines black, blue, red, magenta, green, cyan, yellow, and white as the representative colors.

9. The image processing apparatus of claim 7, wherein all ranges between the gray values assigned to the representative colors are uniform.

10. The image processing apparatus of claim 7, wherein the image processor assigns the gray values to the representative colors to compensate for a characteristic of brightness output of a printing apparatus to print the converted gray image.

11. The image processing apparatus of claim 10, wherein the degree of similarity corresponds to a relative position of a point corresponding to the arbitrary color to points to corresponding to the representative colors in an RGB color space.

12. The image processing apparatus of claim 5, wherein the image processor gives gray values of greater weight to points, among the points corresponding to the representative colors, which are closer to the point of the arbitrary color in the RGB color space.

13. An image processing method to change color printing data to monochromatic printing data, comprising:
determining a plurality of representative colors of the color printing data;
assigning non-overlapping gray value ranges for each of the representative colors determined; and
assigning a grey value to each color of the color printing data according to the non-overlapping gray value range of the corresponding representative color.

14. The method of claim 13, wherein the assigning of the grey value to each color comprises
determining a degree of similarity between a color of the color printing data and the determined representative colors; and
assigning a grey value among the gray value range of the corresponding representative color based on the degree of similarity.

15. The method of claim 14, wherein:
the determining of the plurality of representative colors comprises converting the color printing data into an RGB color space; and
the degree of similarity corresponds to a relative position of a point corresponding to the color to points corresponding to the representative colors in the RGB color space.

16. The method of claim 13, wherein the assigning of the non-overlapping gray value ranges for each of the representative colors determined comprises assigning non-overlapping gray value ranges according to NTSC guidelines.

17. The method of claim 13, wherein the assigning of the non-overlapping gray value ranges for each of the representative colors determined comprises assigning non-overlapping gray value ranges in a specific order to improve distinction of a particular representative color.

18. The method of claim 13, further comprising:
storing a predetermined lookup of non-overlapping grey values ranges corresponding to predetermined colors,
wherein the assigning of the non-overlapping gray value ranges for each of the representative colors determined is performed according to the lookup table.
